(19) United States
(12) Patent Application Publication
(10) Pub. No.: US 2007/0208474 A1
(43) Pub. Date: Sep. 6, 2007

(54) Safety Device and Method for a Motor Vehicle

(76) Inventors: Frank Bertele, Dettenhausen (DE); Roland Breitner, Herrenberg (DE); Dominic Reutter, Birenbach (DE); Ulrich Woerner, Weil Der Stadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/578,423

(22) PCT Filed: Apr. 8, 2005
(86) PCT No.: PCT/EP05/03717

§ 371 Date: Dec. 21, 2006

(30) Foreign Application Priority Data
Apr. 14, 2004 (DE) 10 2004 017 985.9

(51) Int. Cl. B60R 22/00

(52) U.S. Cl. 701/45

(57) ABSTRACT

A safety device for a motor vehicle and related method, in which a head restraint is provided on a seat backrest of a vehicle seat, as well as a control unit with an evaluation of data relevant to safety during driving. The control unit temporally activates a head restraint displacing drive so that, before an accident event which can be anticipated occurs, a positioning of the head restraint into a head restraint setting for an occupant that is safety-optimum is initiated. The safety-optimized head restraint setting is dependent on the current backrest inclination setting of the seat backrest of the vehicle seat.

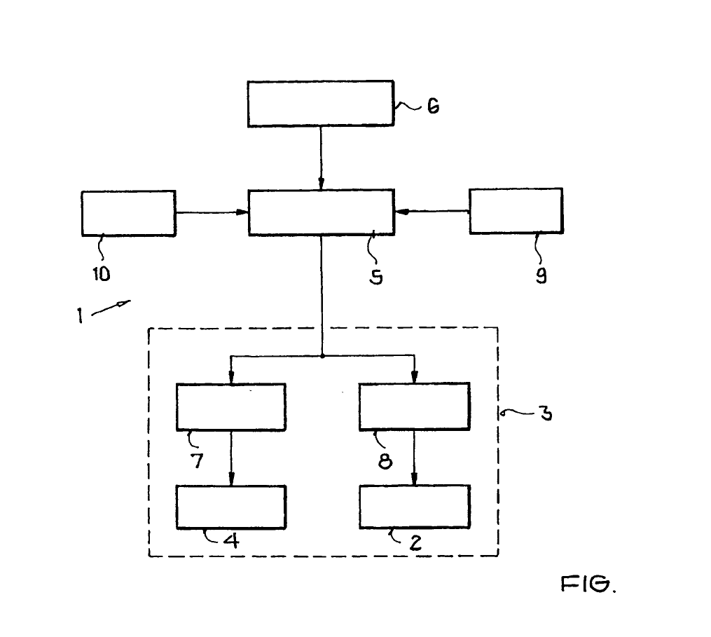

### CROSS REFERENCE TO RELATED APPLICATIONS

This application is a U.S. National Phase Entry under of 35 U.S.C. § 371, of PCT/EP2005/003717, filed Apr. 8, 2005, which claims priority to DE 102004017985.9, filed Apr. 14, 2004, the contents of each of which are incorporated by reference herein in their entirety.

This application is also related to International Application No. PCT/EP2005/003807 (which claims priority to DE 102004020049.1, filed Apr. 23, 2004), also filed as a U.S. National Phase Entry under 35 U.S.C. § 371, serial number to be assigned, and, referenced as Attorney Docket Number 095309.58324US.

### BACKGROUND AND SUMMARY OF THE INVENTION

The present invention relates to a safety device for a motor vehicle, with a head restraint provided on a seat backrest of a vehicle seat, and a control unit with an evaluation of data relevant to safety during driving.

DE 199 47 318 A1 discloses a vehicle with a seat backrest and a head restraint provided on the latter, and with an activating means, containing a crash sensor or precrash sensor, for the crash-induced vertical movement of parts of the head restraint into an operating position above the backrest. The head restraint is supported in its operating position on the vehicle roof and has two parts that are arranged telescopically one inside the other only in crash-free times and which, in the event of a crash, are moveable vertically with respect to each other.

In addition, DE 100 47 406 A1 describes a head restraint for a motor vehicle, with a fixed support part and a moveable, prestressed part. Thereby, the moveable part can be moved from a normal position into a protective position. The movement of the moveable part from the normal position into the protective position takes place when a crash is sensed. A triggering unit for the moveable part is triggered by an electric pulse of a crash sensor.

In addition, DE 101 21 386 C1 discloses a method for activating a reversible occupant protection means in a motor vehicle with a sensor recording driving state data. The driving state data monitored include emergency braking situations, and over- and understeering operations of the motor vehicle. The occupant protection means is triggered as a function of such a state. The driving state data can additionally be used to determine the direction from which a maximum hazard is to be anticipated. The occupant protection means is activated in such a manner that the protective effect takes place in accordance with the direction of maximum hazard.

Furthermore, DE 44 11 184 C2 describes a restraint belt system for a seat in a vehicle, with a seatbelt and a belt tightener for securing a passenger on the seat. A device is used to determine the distance from an object and the corresponding relative speed. From this, the anticipated time until the possible collision between the vehicle and the object can be determined. A control unit generates a control signal which increases the force of the belt tightener in good time before the possible collision. If a collision can be avoided, the force of the belt tightener is decreased again. The controllable belt tightener is designed as a pre-tightener which is only effective up to a predetermined prestress before the collision, with a further belt tightener being trigger to pull the seatbelt tighter if the collision is actually established.

An object of the present invention is to provide a safety device for a motor vehicle, with a head restraint provided on a seat backrest of a vehicle seat, and with a control unit with an evaluation of data relevant to the safety during driving, which safety device has increased occupant protection in comparison to prior art safety devices.

The abovementioned object has been achieved by a method and safety device for a motor vehicle, with a head restraint provided on a seat backrest of a vehicle seat, and with a control unit with an evaluation of data relevant to safety during driving, in which the head restraint setting which is optimum in terms of safety is dependent on the current backrest inclination setting of the seat backrest of the vehicle seat.

The safety device for the motor vehicle, with the head restraint provided on the seat backrest of the vehicle seat, comprises a control unit with the evaluation of data relevant to the safety during driving. The control unit temporally activates a head restraint displacing drive so that, before an accident event which can be anticipated occurs, a positioning of the head restraint into the head restraint setting for the occupant that is optimum in terms of safety is initiated. The individualized setting of the head restraint setting, which is optimum in terms of safety, in coordination with the current inclination of the seat backrest provides increased occupant protection for the occupant sitting on the vehicle seat, in particular a vehicle seat in the rear of the motor vehicle.

For every possible inclination of the seat backrest, a head restraint setting which is optimum in terms of safety is defined by a coupling curve. In the event of the occupant rebounding into the vehicle seat during the actual sequence of the accident event, the occupant's head is received by the head restraint in an optimized manner in terms of safety. For example, a jamming of the head between window pane and rear parcel shelf in swerving and overturning scenarios of the motor vehicle can be avoided by the head restraint setting which is optimized in terms of safety, on account of the formation of a barrier. Even the time directly before the accident event is used in order to initiate the precautionary measures to improve the occupant's safety. With the safety device acting in a preventive manner, a preventive protection of the occupant is provided.

In one embodiment of the invention, before the accident event which can be anticipated occurs, a positioning of the seat backrest into a backrest inclination setting which is optimum in terms of safety is additionally initiated by a backrest inclination displacing drive. With the additional setting of the backrest inclination setting which is optimum in terms of safety, the protection of the occupant is further increased. In this case, it is advantageous if the positioning of the head restraint and of the seat backrest takes place in a temporally correlated manner. The predetermined target position is reached more rapidly and an undesirable relative distance that may form between the head restraint and seat backrest in the event of a temporally separated positioning of these two vehicle seat components can be avoided.

In a further embodiment of the invention, the backrest inclination setting, that is optimum in terms of safety, of the seat backrest is dependent on a current longitudinal position and/or a current seat cushion inclination of a seat cushion of the vehicle seat. The longitudinal position and/or the inclination of the seat cushion can, if appropriate, likewise be transferred in each case into settings that are optimized in terms of safety.

The data relevant to safety during driving can be, in particular, driving state variables. Other variables such as vehicle speed, yaw, longitudinal and transverse accelerations, brake pedal and gas pedal position and the steering angle are also useable as driving state variables. Furthermore, the status of operating elements such as indicators and hazard warning signal, and the status of sensors and control devices relevant to the motor vehicle can be used as driving state variable.

Alternatively or in addition, the data relevant to safety during driving can be ambient data. Ambient data refer to data which are provided by ambient sensors, telematics systems and by communication of the motor vehicle with other motor vehicles and stationary communication systems. Examples of ambient data are information on the current location, on the road category and on the driving lane in which the particular vehicle is driving. Further ambient data include road state, temperature, weather, light conditions and speed, distance, type and size of preceding, adjacent, following or oncoming motor vehicles and of other traffic participants.

It is also advantageous if the data relevant to safety during driving are evaluated driver activities. Detection of the driver activity includes, for example, recognition of the eye movement, the viewing direction but also the operations of operating elements, such as, for example, steering wheel, transmission selector lever and brake pedal. Evaluation of a plurality of data relevant to safety makes it possible, if the need arises, to use the control unit to determine the correct time for positioning the head restraint into a head restraint setting which is optimum in terms of safety.

### BRIEF DESCRIPTION OF THE DRAWINGS

An embodiment of the present invention is described in greater detail on the basis of the drawings, in which:

The single figure is a block circuit diagram showing an excerpt of a safety device for a motor vehicle, and a head restraint provided on a seat backrest of a vehicle seat, and with a control unit with an evaluation of data relevant to safety during driving.

### DETAILED DESCRIPTION OF THE INVENTION

A safety device 1 for a motor vehicle comprises a head restraint 4 provided on a seat backrest 2 of a vehicle seat 3, and a control unit 5 with an evaluation of data 6 relevant to safety during driving. The vehicle seat 3 is, in particular, a rear seat of the motor vehicle.

The control unit 5 activates a head restraint displacing drive 7 and a backrest inclination displacing drive 8 temporally so that, before an accident event which can be anticipated occurs, a positioning of the head restraint 4 into a safety-optimized head restraint setting, and a positioning of the seat backrest 2 into a safety-optimized backrest inclination setting for an occupant on the vehicle seat 3 is initiated.

The positioning of the head restraint 4 and of the seat backrest 2 into their respective safety-optimized position takes place in a temporally correlated manner, i.e. their displacements are actuated at the same time. The positioning of the head restraint 4 and the seat backrest 2 can take place both from smaller to larger angles of inclination and from larger to smaller angles of inclination for the inclination of the head restraint and for the inclination of the seat back. If appropriate, a coordination of the head restraint 4 in terms of height can also take place, which is brought about by an electromotive displacing force.

The safety-optimized head restraint setting is dependent on the backrest inclination setting, of the seat backrest 2 of the vehicle seat 3. In this case, it is advantageous if the safety-optimized head restraint setting of the head restraint 4 and/or the safety-optimized inclination setting of the seat backrest 2 is/are reached before the accident event occurs. If the accident event does not occur, the head restraint 4 and the seat backrest 2 are moved back again into their original settings. The data 6 relevant to safety during driving are driving state variables, ambient data and/or evaluated driver activities.

In a further simplified embodiment, before the accident event which can be anticipated occurs, only a positioning of the head restraint 4 into the safety-optimized head restraint setting is initiated. In this embodiment, the safety-optimized head restraint setting is dependent on the current backrest inclination setting of the seat backrest 2 of the vehicle seat 3.

The safety-optimized inclination setting of the seat backrest can be dependent on a current longitudinal position and/or a current inclination of a seat cushion of the vehicle seat 3. Likewise, the safety-optimized inclination setting of the seat backrest 2 can be dependent on the usage state of a belt system 9 of the vehicle seat 3. The temporal sequence of operations that are to be carried out to displace the vehicle seat 3 before an accident event occurs can also be pre-set as a function of the usage state of the belt system 9.

In addition, an occupant classification 10 can be provided for the vehicle seat 3, so that the setting of the safety-optimized head restraint setting and/or the safety-optimized setting of the inclination setting of the seat backrest 2 takes/take place as a function of the occupant classification 10. The setting can be made dependent, for example, on the size, the weight, the constitution and/or the age of the occupant.

The safety device 1 according to the invention ensures that an occupant sitting on the vehicle seat 3 is well protected. The head restraint 4 and, if appropriate, the seat backrest 2 can in each case be brought, even before the accident event occurring, into a safety-optimized head restraint setting or backrest inclination setting and are defined as a function of various boundary conditions.

1-10. (canceled)

11. A safety device for a motor vehicle, having a head restraint provided on a seat backrest of a vehicle seat, comprising a control unit configured to evaluate data relevant to safety during driving and to temporally activate a head restraint displacing drive so that, before occurrence of an anticipated accident event, a positioning of the head restraint into a safety-optimized head restraint setting for an occupant is initiated, wherein the safety-optimized head restraint setting is a function of a current backrest inclination setting of the seat backrest of the vehicle seat.

12. The safety device as claimed in claim 11, wherein before occurrence of the accident event, a positioning of the seat backrest into a safety-optimized backrest inclination setting is additionally initiated by a backrest inclination displacing drive.

13. The safety device as claimed in claim 12, wherein the positioning of the head restraint and of the seat backrest takes place in a temporally correlated manner.

14. The safety device as claimed in claim 12, wherein the safety-optimized backrest inclination setting of the seat backrest is a function of at least one of a current longitudinal position and a current seat cushion inclination of a seat cushion of the vehicle seat.

15. The safety device as claimed in claim 12, wherein the safety-optimized inclination setting of the seat backrest is a function of a usage state of a belt system of the vehicle seat.

16. The safety device as claimed in claim 12, wherein an occupant classification is provided for the vehicle seat, so that the safety-optimized head restraint setting functions in relation to the occupant classification.

17. The safety device as claimed in claim 16, wherein the function relates to at least one of size and weight of a vehicle occupant.

18. The safety device as claimed in claim 11 wherein the vehicle seat is a rear seat of the motor vehicle.

19. The safety device as claimed in claim 11, wherein the data relevant to safety during driving include at least one of driving state variables, ambient data, and evaluated driver activities.

20. The safety device as claimed in claim 12, wherein at least one of the safety-optimized head restraint setting and the safety-optimized inclination setting of the seat backrest is reached before the accident event occurs.

21. The safety device as claimed in claim 11, wherein the head restraint and the seat backrest are moved back again into their original settings if the accident does not occur as anticipated.

22. A method comprising:
evaluating data relevant to safety during driving of a motor vehicle; and
temporarily activating a head restraint displacing drive before occurrence of an anticipated accident event based on the evaluated data to position a head restraint for a vehicle occupant in a safety-optimized setting as a function of a current backrest inclination setting of a vehicle seat backrest.

23. The method as claimed in claim 22, wherein before occurrence of the accident event, a positioning of the seat backrest into a safety-optimized backrest inclination setting is additionally initiated by a backrest inclination displacing drive.

24. The method as claimed in claim 23, wherein the positioning of the head restraint and of the seat backrest takes place in a temporally correlated manner.

25. The method as claimed in claim 23, wherein the safety-optimized backrest inclination setting of the seat backrest is a function of at least one of a current longitudinal position and a current seat cushion inclination of a seat cushion of the vehicle seat.

26. The method as claimed in claim 23, wherein the safety-optimized inclination setting of the seat backrest is a function of a usage state of a belt system of the vehicle seat.

27. The method as claimed in claim 23, wherein an occupant classification is provided for the vehicle seat, so that the safety-optimized head restraint setting functions in relation to the occupant classification.

28. The method as claimed in claim 22, wherein the data relevant to safety during driving include at least one of driving state variables, ambient data, and evaluated driver activities.

29. The method as claimed in claim 23, wherein at least one of the safety-optimized head restraint setting and the safety-optimized inclination setting of the seat backrest is reached before the accident event occurs.

30. The method as claimed in claim 22, wherein the head restraint and the seat backrest are moved back again into their original settings if the accident does not occur as anticipated.
